(19) United States
(12) Patent Application Publication
(10) Pub. No.: US 2020/0153320 A1
(43) Pub. Date: May 14, 2020

(54) METHOD FOR MANUFACTURING ROTOR IRON CORE AND ROTOR IRON CORE

(71) Applicant: MITSUI HIGH-TEC, INC., Fukuoka (JP)

(72) Inventors: Takuya SHINGU, Fukuoka (JP); Hisatomo ISHIMATSU, Fukuoka (JP); Kenji KIMURA, Fukuoka (JP); Akira HYOGUCHI, Fukuoka (JP)

(73) Assignee: MITSUI HIGH-TEC, INC., Fukuoka (JP)

(21) Appl. No.: 16/672,775

(22) Filed: Nov. 4, 2019

(30) Foreign Application Priority Data
Nov. 8, 2018 (JP) 2018-210415

(51) Int. Cl. H02K 15/03; H02K 1/28

(52) U.S. Cl. CPC H02K 15/03; H02K 15/12; H02K 1/28

(57) ABSTRACT

A method for manufacturing a rotor iron core includes providing an iron core body including a magnet-insert hole, and a resin guide member including a wall body projected from a surface of the resin guide member, overlapping the iron core body with the resin guide member, the wall body being positioned inside the magnet-insert hole in which a permanent magnet is disposed in a state where the iron core body is overlapped with the resin guide member, and injecting a molten resin into the magnet-insert hole through at least one gate hole pierced in the resin guide member, a discharge port of the at least one gate hole being provided in lateral vicinity of the wall body.

### CROSS REFERENCE TO RELATED APPLICATION(S)

This application is based upon and claims the benefit of priority of Japanese Patent Application No. 2018-210415 filed on Nov. 8, 2018, the contents of which are incorporated herein by reference in its entirety.

### BACKGROUND OF THE INVENTION

### 1. Field of the invention

The present disclosure relates to a method for manufacturing a rotor iron core and a rotor iron core.

### 2. Description of the Related Art

JP-A-2012-235697 referred to as Patent Reference 1 discloses a method for manufacturing a rotor iron core, the method including a step of inserting a permanent magnet into a magnet-insert hole of an iron core body, and a step of injecting a molten resin into the magnet-insert hole through a gate hole provided in a resin guide member. A discharge port of the gate hole is provided in a top surface of a projection upwardly projected from a surface of the resin guide member. An inside diameter of the discharge port of the gate hole is narrowed gradually toward the top surface of the projection.

Patent Reference 1: JP-A-2012-235697

### SUMMARY OF THE INVENTION

In recent years, for the purpose of, for example, more effectively injecting a molten resin into a magnet-insert hole and more improving a weight balance of a rotor iron core, it is desirable to properly manage a position of a permanent magnet with respect to a magnet-insert hole.

Hence, the present disclosure describes a method for manufacturing a rotor iron core, capable of properly managing a position of a permanent magnet with respect to a magnet-insert hole, and the rotor iron core.

A method for manufacturing a rotor iron core according to an aspect of the present disclosure includes: providing an iron core body including a magnet-insert hole, and a resin guide member including a wall body projected from a surface of the resin guide member; overlapping the iron core body with the resin guide member, wherein the wall body is positioned inside the magnet-insert hole in which a permanent magnet is disposed in a state where the iron core body is overlapped with the resin guide member; and injecting a molten resin into the magnet-insert hole through at least one gate hole pierced and extended in the resin guide member, wherein a discharge port of the at least one gate hole is provided in lateral vicinity of the wall body.

A rotor iron core according to another aspect of the present disclosure includes: an iron core body including a magnet-insert hole; a permanent magnet arranged inside the magnet-insert hole; and a solidified resin provided inside the magnet-insert hole to hold the permanent magnet inside the magnet-insert hole. The solidified resin includes: a recess formed in an end on a side of one end face of the iron core body; and an auxiliary recess formed in the end of the iron core body, the auxiliary recess being shallower than the recess. The auxiliary recess is positioned in lateral vicinity of the recess. The permanent magnet is positioned closer to an inner wall surface of the magnet-insert hole on a side opposite to the auxiliary recess with respect to the recess.

The method for manufacturing the rotor iron core, and the rotor iron core according to the aspects of the present disclosure can properly manage the position of the permanent magnet with respect to the magnet-insert hole.

### BRIEF DESCRIPTION OF THE DRAWINGS

In the accompanying drawings:

FIG. 1 is a perspective view showing one example of a rotor laminated iron core when viewed from above;

FIG. 2 is a perspective view showing one example of the rotor laminated iron core when viewed from below;

FIG. 3 is a sectional view taken on line III-III of FIG. 2;

FIG. 4 is an enlarged view of part IV of FIG. 3;

FIG. 5 is a partially enlarged perspective view showing the vicinity of an end recess when viewed from above;

FIG. 6 is a schematic diagram showing one example of an apparatus for manufacturing the rotor laminated iron core;

FIG. 7 is a sectional view describing one example of attaching permanent magnets to magnet-insert holes by a magnet attachment device;

FIG. 8 is a partially enlarged perspective view showing one example of a protrusion;

FIG. 9 is an enlarged view of part VII of FIG. 7;

FIGS. 10A and 10B are partially enlarged perspective views showing another example of the protrusion;

FIGS. 11A and 11B are partially enlarged perspective views showing a further example of the protrusion;

FIGS. 124 and 12B are partially enlarged perspective views showing a further example of the protrusion;

FIG. 13 is a sectional view describing another example of attaching permanent magnets to magnet-insert holes by the magnet attachment device; and

FIG. 14 is a partially enlarged perspective view showing the vicinity of an end recess when viewed from above in another example of the rotor laminated iron core.

### DETAILED DESCRIPTION OF THE EXEMPLARY EMBODIMENTS

One example of an embodiment according to the present disclosure will hereinafter be described in more detail with reference to the accompanying drawings. In the following description, the same numerals and signs are used for the same elements or elements having the same functions, and overlap description is omitted.

### Configuration of Rotor Laminated Iron Core

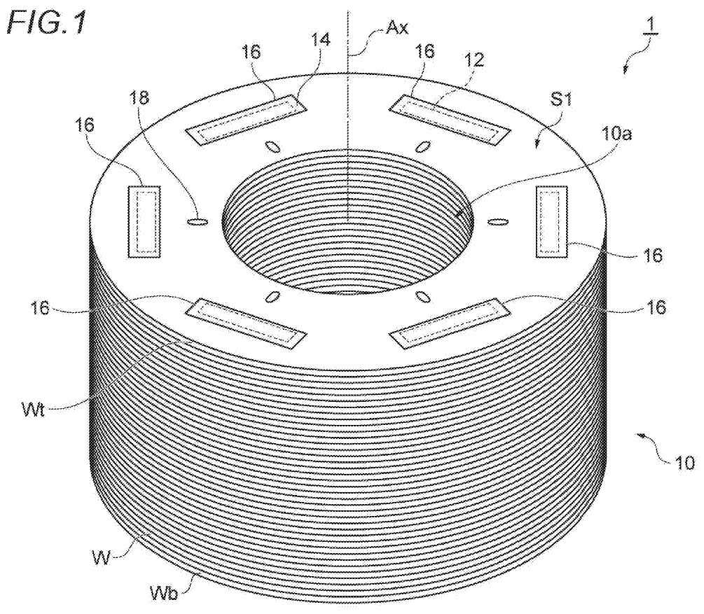

Referring first to FIGS. 1 to 5, a configuration of a rotor laminated iron core 1 will be described. The rotor laminated iron core 1 (rotor iron core) is a portion of a rotor (rotor). The rotor is formed by attaching a shaft (not shown) to the rotor laminated iron core 1. The rotor is combined with a stator (stator), thereby forming an electric motor (motor). The rotor laminated iron core 1 illustrated in FIG. 1 may form a portion of an embedded type magnet (IPM) motor.

As shown in FIGS. 1 to 3, the rotor laminated iron core 1 includes a laminated body 10 (iron core body), a plurality of permanent magnets 12, and a plurality of solidified resins 14.

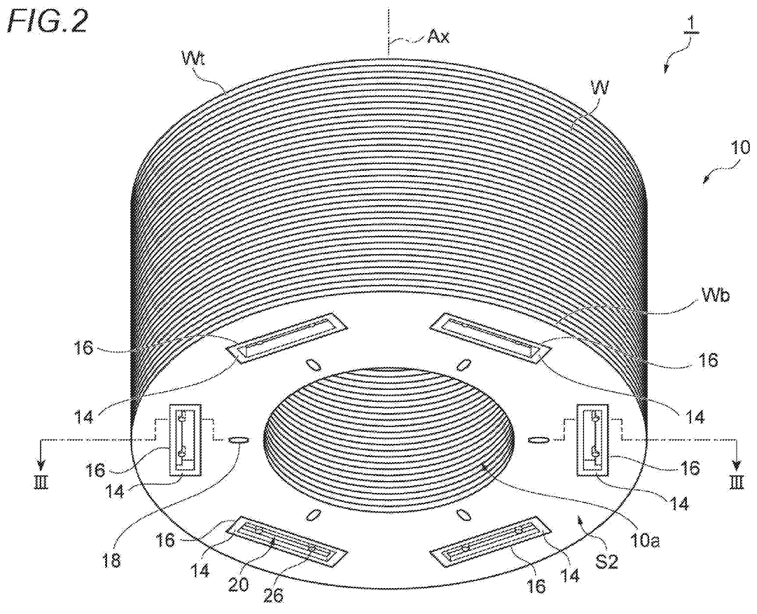

As shown in FIGS. 1 and 2, the laminated body 10 has a cylindrical shape. The center of the laminated body 10 is provided with a shaft hole 10a pierced in the laminated body 10 so as to extend along a central axis Ax. That is, the shaft hole 10a extends in a height direction (lamination direction) of the laminated body 10. In one example, since the laminated body 10 rotates around the central axis Ax, the central axis Ax is also the axis of rotation, A shaft can be inserted into the shaft hole 10a.

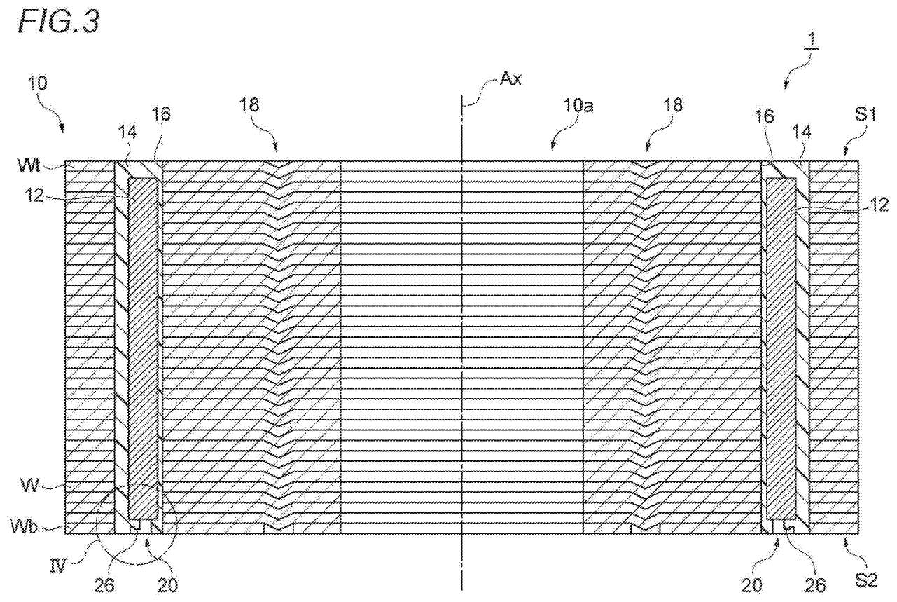

The laminated body 10 includes a plurality of magnet-insert holes 16. As shown in FIGS. 1 and 2, the magnet-insert holes 16 are arranged at predetermined distances along an outer peripheral edge of the laminated body 10. As shown in FIG. 3, the magnet-insert hole 16 is pierced in the laminated body 10 so as to extend along the height direction. A shape of the magnet-insert hole 16 in the case of being viewed from the height direction may be an elongated hole extending along the outer peripheral edge of the laminated body 10. The number of magnet-insert holes 16 is not particularly limited, and may be, for example, six. Positions, shapes, and the number of magnet-insert holes 16 may be changed according to applications of the motor, required performance, etc.

As shown in FIGS. 1 to 3, the laminated body 10 is formed by stacking a plurality of blanked members W. An upper surface of a blanked member Wt forming the uppermost layer of the plurality of blanked members W forms an upper end face S1 of the laminated body 10 (see FIGS. 1 and 3). A lower surface of a blanked member Wb forming the lowermost layer of the plurality of blanked members W forms a lower end face S2 of the laminated body 10 (see FIGS. 2 and 3).

The blanked member W is a plate-shaped body formed by blanking an electromagnetic steel plate ES described below in a predetermined shape, and has a shape corresponding to the laminated body 10. The laminated body 10 may be formed by the so-called rotation and lamination. The “rotation and lamination” means that the plurality of blanked members W are laminated while relatively angle-shifting the blanked members W. The rotation and lamination are performed for the purpose of mainly offsetting a plate thickness deviation of the laminated body 10. The angle of the rotation and lamination may be set in any size.

As shown in FIGS. 1 to 3, the mutual blanked members W adjacent in the height direction may be interlocked by caulking parts 18. These mutual blanked members W may be interlocked by various publicly known methods instead of the caulking parts 18. For example, the plurality of blanked members W may be mutually bonded using an adhesive or a resin material, or by welding. Alternatively, the blanked members W may be provided with caulking blocks and the plurality of blanked members W may be interlocked through the caulking blocks to obtain the laminated body 10 and then, the caulking blocks may be removed from this laminated body. In addition, the “caulking blocks” means caulking used to temporarily integrate the plurality of blanked members W and removed in a process of manufacturing a product (rotor laminated iron core 1).

As shown in FIGS. 1 and 3, the permanent magnet 12 is inserted into each of the magnet-insert holes 16 one by one. A shape of the permanent magnet 12 is not particularly limited, and may have, for example, a rectangular parallelepiped shape. A kind of permanent magnet 12 may be determined according to applications of the motor, required performance, etc., and may be, for example, a sintered magnet or a bond magnet.

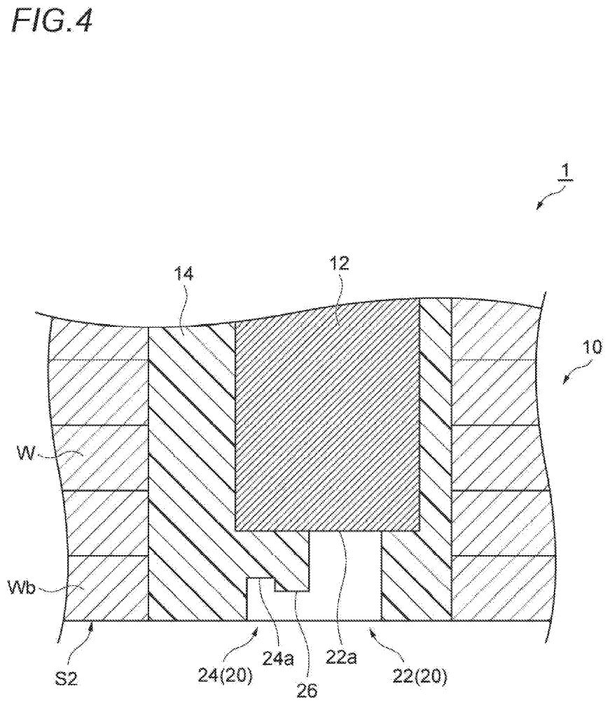

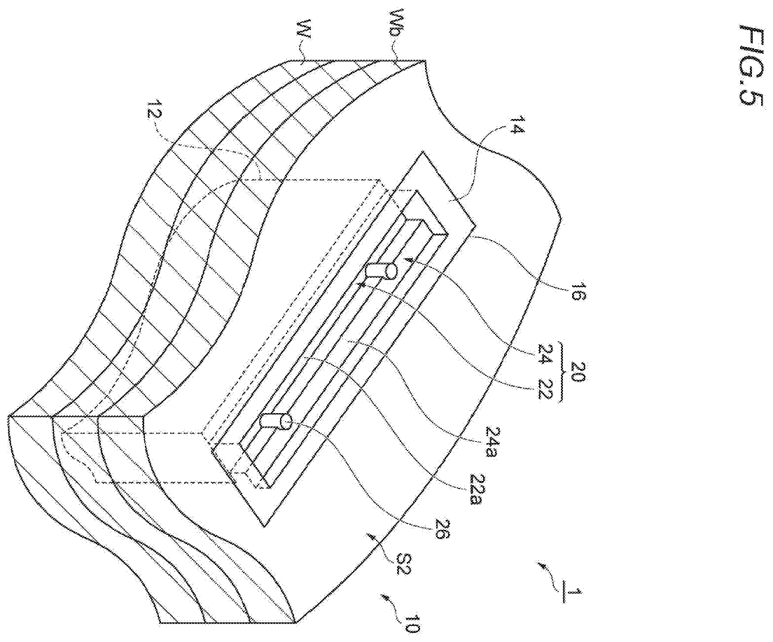

The permanent magnet 12 may be positioned in substantially the center of the magnet-insert hole 16, or may be arranged in an eccentric position with respect to the magnet-insert hole 16 in the case of being viewed from the height direction. As illustrated in FIGS. 4 and 5, the permanent magnet 12 may be positioned closer to an inner wall surface of the magnet-insert hole 16 on a side opposite to an auxiliary recess 24 (described below) with respect to a recess 22 (described below).

As shown in FIGS. 1 to 3, in the solidified resin 14, the magnet-insert hole 16 after inserting the permanent magnet 12 is filled with a resin material (molten resin) in a molten state and then, this molten resin is solidified. The solidified resin 14 has a function of fixing the permanent magnet 12 in the magnet-insert hole 16, and a function of bonding the mutual blanked members W adjacent in the height direction. The resin material forming the solidified resin 14 includes, for example, a thermosetting resin, a thermoplastic resin, etc. A concrete example of the thermosetting resin includes, for example, a resin composition including an epoxy resin, a curing initiator, and an additive agent. The additive agent includes, for example, a filler, a flame retardant, a stress reducing agent, etc.

As shown in FIGS. 2 and 3, the lower end of the solidified resin 14 is formed with an end recess 20. As shown in FIGS. 4 and 5 in more detail, the end recess 20 includes the recess 22, and the auxiliary recess 24.

The recess 22 is recessed from the lower end face S2 toward the permanent magnet 12. As illustrated in FIG. 4, the recess 22 may be a through-hole extending from the lower end face S2 to the location of the permanent magnet 12. In this case, a portion of a lower end face of the permanent magnet 12 is exposed through the recess 22, and forms a recess bottom surface 22a of the recess 22. It is unnecessary that the recess 22 should be a through-hole (not shown). That is, the recess bottom surface 22a of the recess 22 is formed of the solidified resin 14, and it is unnecessary that the permanent magnet 12 should be exposed through the recess 22. As illustrated in FIG. 5, the recess 22 may be a recessed groove extending along a longitudinal direction of the magnet-insert hole 16.

As shown in FIGS. 4 and 5, the auxiliary recess 24 is recessed from the lower end face S2 toward the permanent magnet 12. The depth of the auxiliary recess 24 is shallower than the depth of the recess 22. That is, a recess bottom surface 24a of the auxiliary recess 24 does not reach the lower end face of the permanent magnet 12, As illustrated in FIG. 5, the auxiliary recess 24 may be a recessed groove extending along the longitudinal direction of the magnet-insert hole 16.

The auxiliary recess 24 is positioned in the lateral vicinity of the recess 22. As illustrated in FIGS. 4 and 5, the auxiliary recess 24 may be continuously adjacent to the recess 22. That is, the auxiliary recess 24 may be integrated with the recess 22, and space in the auxiliary recess 24 may communicate with space in the recess 22. In this case, a step is formed at the boundary between the auxiliary recess 24 and the recess 22. That is, the end recess 20 may be a recess having a stepwise cross section.

The inside of the end recess 20 is provided with a gate mark 26. The gate mark 26 is connected integrally to the solidified resin 14. The gate mark 26 is outwardly projected from the recess bottom surface 22a of the recess 22 and the recess bottom surface 24a of the auxiliary recess 24. In the example shown in FIGS. 4 and 5, the gate mark 26 is provided astride the step of the recess 22 and the auxiliary recess 24. That is, a portion of the gate mark 26 is outwardly projected from the recess bottom surface 22a of the recess 22, and the residue of the gate mark 26 is outwardly projected from the recess bottom surface 24a of the auxiliary recess 24. It is unnecessary that the top of the gate mark 26 should be projected to the outside beyond the lower end face S2. That is, the gate mark 26 may be positioned inside the end recess 20,

### Apparatus for Manufacturing Rotor Laminated Iron Core

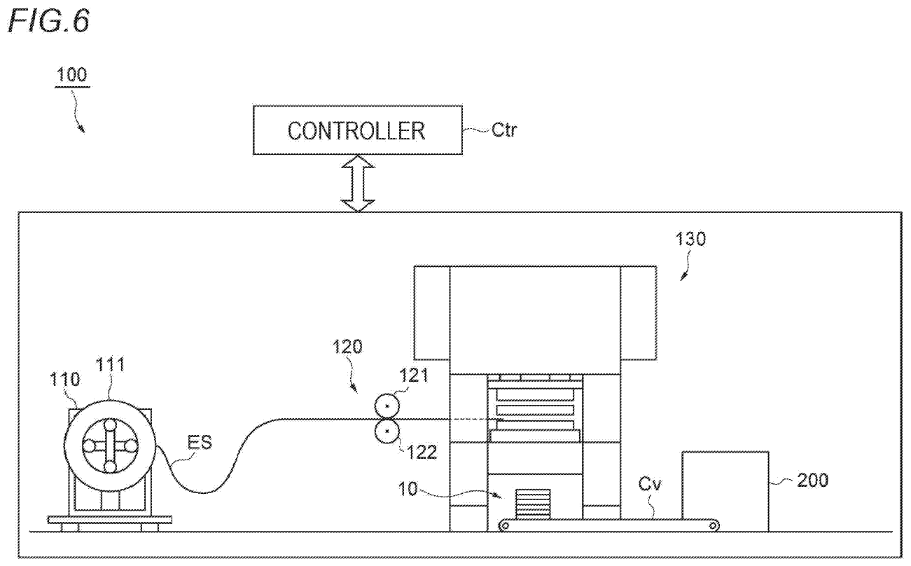

Subsequently, an apparatus 100 for manufacturing a rotor laminated iron core 1 will be described with reference to FIGS. 6 to 9.

The manufacturing apparatus 100 is an apparatus for manufacturing the rotor laminated iron core 1 from an electromagnetic steel plate ES (workpiece plate) which is a strip-shaped metal plate. As shown in FIG. 6, the manufacturing apparatus 100 includes an uncoiler 110, a delivery device 120, a blanking device 130, a magnet attachment device 200 (resin injection device), and a controller Ctr (control part).

The uncoiler 110 holds a coil material 111 rotatably with the coil material 111 mounted, the coil material 111 being the strip-shaped electromagnetic steel plate ES wound in a coil state. The delivery device 120 has a pair of rollers 121, 122 for pinching the electromagnetic steel plate ES from above and below. The pair of rollers 121, 122 rotates and stops based on instruction signals from the controller Ctr, and sequentially delivers the electromagnetic steel plate ES intermittently toward the blanking device 130.

The blanking device 130 operates based on the instruction signals from the controller Ctr. The blanking device 130 has a function of sequentially blanking the electromagnetic steel plate ES intermittently delivered by the delivery device 120 and forming blanked members W, and a function of sequentially laminating the blanked members W obtained by the blanking work and manufacturing a laminated body 10.

After the laminated body 10 is ejected from the blanking device 130, the laminated body 10 is placed on a conveyor Cv provided so as to extend between the blanking device 130 and the magnet attachment device 200. The conveyor Cv operates based on instructions from the controller Ctr, and delivers the laminated body 10 to the magnet attachment device 200. In addition, the laminated body 10 may be conveyed without the conveyor Cv between the blanking device 130 and the magnet attachment device 200. For example, the laminated body 10 may be conveyed by hand with the laminated body 10 placed on a container.

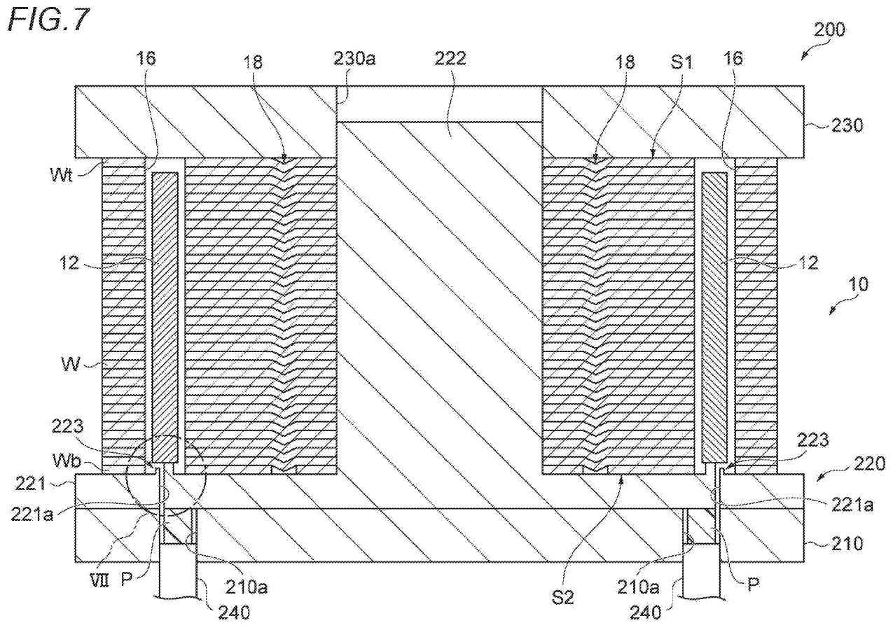

The magnet attachment device 200 operates based on the instruction signals from the controller Ctr. The magnet attachment device 200 has a function of inserting the permanent magnet 12 into each of the magnet-insert holes 16, and a function of filling the inside of the magnet-insert hole 16, into which the permanent magnet 12 is inserted, with a molten resin. As shown in FIG. 7 in detail, the magnet attachment device 200 includes a lower die 210, a resin guide member 220, an upper die 230, and a plurality of plungers 240.

The lower die 210 has a function of pinching the resin guide member 220 and the laminated body 10 between the lower die 210 and the upper die 230, a function of heating the laminated body 10 by a built-in heat source (not shown), and a function of supporting the laminated body 10 and the resin guide member 220. The lower die 210 may be, for example, a plate-shaped member having a rectangular shape.

The lower die 210 is provided with a plurality of receiving holes 210a pierced in the lower die 210. The plurality of receiving holes 210a are arranged at predetermined distances so as to be positioned in places corresponding to the magnet-insert holes 16 with the laminated body 10 pinched by the lower die 210 and the upper die 230. Each of the receiving holes 210a has a columnar shape, and can receive at least one resin pellet P.

The resin guide member 220 includes a base member 221, and an insertion post 222 provided on the base member 221. The base member 221 is constructed so that the laminated body 10 can be placed. The base member 221 may be, for example, a plate-shaped member having a rectangular shape. The insertion post 222 is positioned in substantially the center of the base member 221, and is upwardly projected from an upper surface of the base member 221. The insertion post 222 has a columnar shape, and has an external shape corresponding to the shaft hole 10a of the laminated body 10.

The base member 221 is provided with a plurality of gate holes 221a pierced in the base member 221. The gate holes 221a are arranged at predetermined distances so as to be positioned in places corresponding to the magnet-insert holes 16 and the receiving holes 210a with the laminated body 10 pinched by the lower die 210 and the upper die 230.

The base member 221 is provided with a plurality of protrusions 223 upwardly projected from the upper surface of the base member 221. The plurality of protrusions 223 are arranged at predetermined distances along the periphery of the insertion post 222 so as to be positioned in places corresponding to the magnet-insert holes 16 with the laminated body 10 placed on the base member 221.

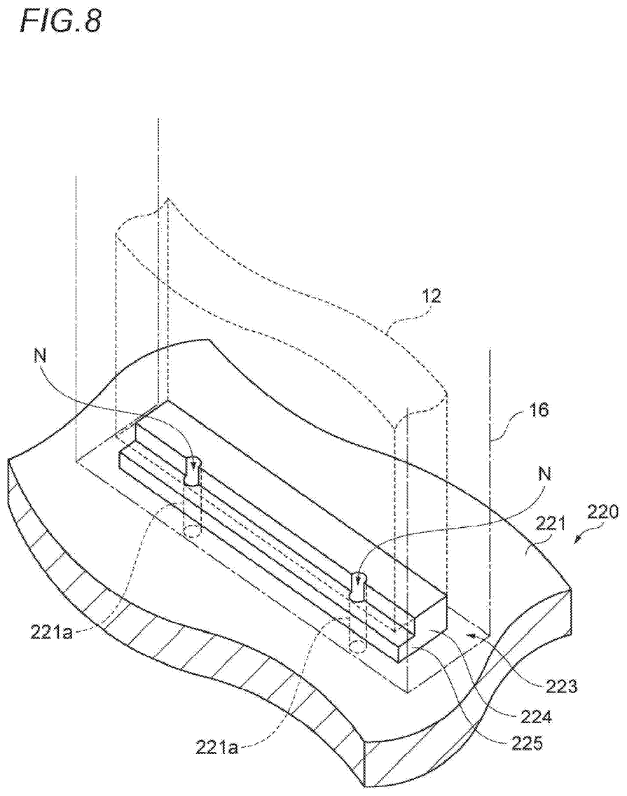

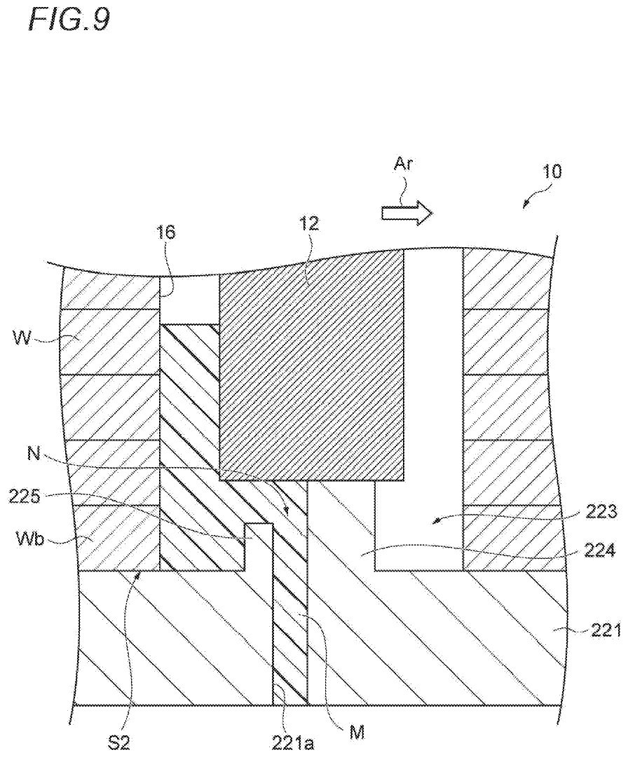

As shown in FIGS. 8 and 9 in more detail, the protrusion 223 has a shape corresponding to an end recess 20. Each of the protrusions 223 includes a wall body 224, and an auxiliary wall body 225.

The wall body 224 has a shape corresponding to a recess 22. As illustrated in FIG. 8, the wall body 224 may be a protrusion strip extending along a longitudinal direction of the magnet-insert hole 16.

The auxiliary wall body 225 has a shape corresponding to an auxiliary recess 24. The height of the auxiliary wall body 225 is lower than the height of the wall body 224. As illustrated in FIG. 8, the auxiliary wall body 225 may be a protrusion strip extending along the longitudinal direction of the magnet-insert hole 16. The auxiliary wall body 225 may be positioned in the lateral vicinity of the wall body 224. As illustrated in FIGS. 8 and 9, the auxiliary wall body 225 may be connected integrally to the wall body 224. In this case, a step is formed at the boundary between the auxiliary wall body 225 and the wall body 224. The protrusion 223 may be a protrusion having a stepwise cross section.

The protrusion 223 is provided with at least one gate hole 221a. That is, the gate hole 221a is pierced in the base member 221 and the protrusion 223. A discharge port N of the gate hole 221a is opened in an upper surface of the protrusion 223. In the example shown in FIGS. 8 and 9, the gate hole 221a is provided astride the step between the wall body 224 and the auxiliary wall body 225. That is, a portion of the gate hole 221a is pierced in the wall body 224, and the residue of the gate hole 221a is pierced in the auxiliary wall body 225. In this case, the discharge port N is provided in an upper surface of the wall body 224, a side surface of the wall body 224, and an upper surface of the auxiliary wall body 225. In other words, a portion of the discharge port N provided in the upper surface of the auxiliary wall body 225 is positioned in the lateral vicinity of the wall body 224.

The upper die 230 has a function of pinching the resin guide member 220 and the laminated body 10 between the upper die 230 and the lower die 210, and a function of heating the laminated body 10 by a built-in heat source (not shown). When the upper die 230 and the lower die 210 pinch the laminated body 10, a predetermined load is applied to the laminated body 10 from a height direction. The upper die 230 may be, for example, a plate-shaped member having a rectangular shape. Substantially the center of the upper die 230 is provided with a through-hole 230a pierced in the upper die 230. The through-hole 230a has a shape (substantially a circular shape) corresponding to the insertion post 222, and the insertion post 222 can be inserted into the through-hole 230a.

The plurality of plungers 240 are positioned in the downward side of the lower die 210. Each of the plungers 240 is connected to a driving source (not shown). Each of the driving sources is constructed so as to operate the corresponding plunger 240 based on instructions from the controller Ctr.

The controller Ctr generates instruction signals for respectively operating the delivery device 120, the blanking device 130 and the magnet attachment device 200 based on, for example, a program recorded on a record medium (not shown), or a manipulation input from an operator, and respectively sends the instruction signals to these devices.

### Method for Manufacturing Rotor Laminated Iron Core

Subsequently, a method for manufacturing a rotor laminated iron core 1 will be described with reference to FIGS. 7 and 9. Here, description of a step of forming a laminated body 10 by a blanking device 130 is omitted, and subsequent steps are described.

First, the laminated body 10 is conveyed to a magnet attachment device 200, and the laminated body 10 is placed on a resin guide member 220 so as to be in a state in which an insertion post 222 is inserted into a shaft hole 10a as shown in FIG. 7. In other words, an upper surface of a base member 221 of the resin guide member 220 is overlapped with a lower end face S2 of the laminated body 10. At this time, the insertion post 222 is inserted into the shaft hole 10a of the laminated body 10 and also, each protrusion 223 is positioned inside a corresponding magnet-insert hole 16 one by one.

Next, a permanent magnet 12 is inserted into each of the magnet-insert holes 16. At this time, a lower end face of each of the permanent magnets 12 inserted into each of the magnet-insert holes 16 abuts on an upper end of a wall body 224. Each of the permanent magnets 12 may be inserted into each of the magnet-insert holes 16, for example, by hand, or by a robot hand (not shown) included by the magnet attachment device 200 based on instructions from a controller Ctr.

Then, the laminated body 10 and the resin guide member 220 are pinched by a lower die 210 and an upper die 230, and the laminated body 10 is pressurized at a predetermined pressure. At this time, the insertion post 222 is inserted into a through-hole 230a of the upper die 230 and also, each gate hole 221a is overlapped with a corresponding receiving hole 210a. Accordingly, the receiving hole 210a, the gate hole 221a and the magnet-insert hole 16 become communicated.

Then, a resin pellet P is introduced into each of the receiving holes 210a. When built-in heat sources of the lower die 210 and the upper die 230 operate based on instructions from the controller Ctr in this state, the resin pellet P received in each of the receiving holes 210a is heated. Accordingly, the resin pellet P is molten to change into a molten resin M. In addition, the laminated body 10 may be heated to, for example, about 140° C. to 180° C. by the built-in heat sources.

Then, the controller Ctr instructs a driving source, and operates each plunger 240. Accordingly, the molten resin M is injected into the magnet-insert hole 16 through the gate hole 221a at a predetermined injection pressure. At this time, as illustrated in FIG. 9, the molten resin M discharged from a discharge port N of the gate hole 221a is blocked by a side surface of the wall body 224 and the lower end face of the permanent magnet 12, and flows toward the side of an auxiliary wall body 225. Subsequently, the molten resin M flows between the permanent magnet 12 and an inner wall surface of the magnet-insert hole on a side opposite to the wall body 224 with respect to the auxiliary wall body 225. At this time, the permanent magnet 12 can be moved toward the side of an arrow Ar by a pressure of the molten resin M (see FIG. 9).

Subsequently, when injection of the molten resin M further continues and filling of the magnet-insert hole 16 with the molten resin M is completed and the molten resin M is solidified, the inside of the magnet-insert hole 16 is formed with a solidified resin 14. In this manner, the permanent magnets 12 and the solidified resins 14 are attached to the laminated body 10. After the laminated body 10 is taken out of the magnet attachment device 200, the rotor laminated iron core 1 is completed.

At this time, a lower end of the solidified resin 14 is formed with an end recess 20 (a recess 22 and an auxiliary recess 24) having a shape corresponding to the protrusion 223 (the wall body 224 and the auxiliary wall body 225) of the resin guide member 220. Also, when the resin guide member 220 is detached from the laminated body 10, the solidified resin solidified inside the gate hole 221a is broken in the vicinity of the discharge port N. As a result, a portion of the solidified resin inside the gate hole 221a becomes connected integrally to the solidified resin 14 as a gate mark 26. In addition, when the permanent magnet 12 is moved toward the side of the arrow Ar by the pressure of the molten resin M, the permanent magnet 12 is positioned closer to an inner wall surface of the resin guide member 220 on a side opposite to the auxiliary recess 24 with respect to the recess 22.

### Action

According to the above example, the molten resin M discharged from the discharge port N of the gate hole 221a to the inside of the magnet-insert hole 16 is blocked by the wall body 224, and flows to a side opposite to the wall body 224. As a result, the permanent magnet 12 arranged inside the magnet-insert hole 16 is brought closer to a side of the wall body 224 by the molten resin M flowing to the side opposite to the wall body 224. That is, the permanent magnet 12 is arranged in a predetermined position of the inside of the magnet-insert hole 16 by the flow of the molten resin M. This can properly manage a position of the permanent magnet 12 with respect to the magnet-insert hole 16.

According to the above example, the discharge port N of the gate hole 221a is provided in the wall body 224 and the auxiliary wall body 225. That is, when the molten resin M is injected into the magnet-insert hole 16, the discharge port N is positioned in the inside beyond the lower end face S2 of the laminated body 10. As a result, when the resin guide member 220 is detached from the laminated body 10, the solidified resin inside the gate hole 221a tends to be broken in the inside beyond the lower end face S2 of the laminated body 10. Accordingly, even when the gate mark 26 occurs, the top of the gate mark 26 becomes resistant to being projected to the outside beyond the lower end face S2. As a result, contact between the gate mark 26 and other member is inhibited. This can prevent fall of the gate mark 26 at the time of operation of the rotor laminated iron core 1.

According to the above example, the gate hole 221a is provided astride the wall body 224 and the auxiliary wall body 225. As a result, the molten resin M discharged from the discharge port N collides with the wall body 224 immediately, and tends to flow to the side opposite to the wall body 224. Accordingly, the flow of the molten resin M can be controlled with higher accuracy. This can more properly manage the position of the permanent magnet 12 with respect to the magnet-insert hole 16.

According to the above example, the molten resin M is injected into the magnet-insert hole 16 from the lower side of the laminated body 10 with the resin guide member 220 overlapped with the lower end face S2 of the laminated body 10. As a result, the permanent magnet 12 arranged inside the magnet-insert hole 16 is supported by the wall body 224 positioned on the lower end side of the magnet-insert hole 16. Accordingly, the molten resin M discharged from the discharge port N of the gate hole 221a is blocked by the wall body 224 and a lower end face of the permanent magnet 12, and tends to flow to the side opposite to the wall body 224. This can control the flow of the molten resin M with higher accuracy, and can more properly manage the position of the permanent magnet 12 with respect to the magnet-insert hole 16.

### Modified Examples

The embodiment according to the present disclosure has been described above in detail, but various modifications may be made in the embodiment without departing from the claims and the gist thereof.

(1) The protrusion 223 (the wall body 224 or the auxiliary wall body 225) may have a taper shape. For example, the protrusion 223 may have a frustum shape. In this case, when the resin guide member 220 is detached from the laminated body 10 after the molten resin M is injected and cured, the protrusion 223 tends to be released from the solidified resin 14.

(2) An inner peripheral surface in the vicinity of the discharge port N of the gate hole 221a may have a taper shape toward the top. In this case, when the resin guide member 220 is detached from the laminated body 10 after the molten resin M is injected and cured, a stress tends to act on the solidified resin in the vicinity of the discharge port N of the gate hole 221a. As a result, the gate mark 26 can be decreased. Accordingly, contact between the gate mark 26 and other member is further inhibited. This can effectively prevent fall of the gate mark 26 at the time of operation of the rotor laminated iron core 1.

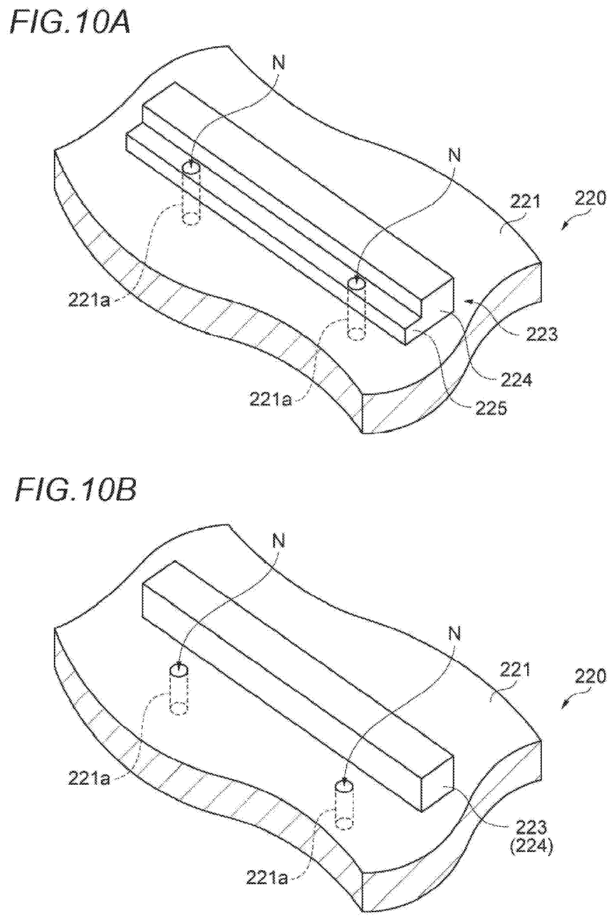

(3) As shown in FIG. 10A, all the discharge port N may be opened in an upper surface of the auxiliary wall body 225, That is, it is unnecessary that the gate hole 221a should be pierced in the wall body 224.

(4) As shown in FIG. 10B, it is unnecessary that the protrusion 223 should include the auxiliary wall body 225. At this time, the discharge port N may be opened in an upper surface of the base member 221 so as to be positioned in the lateral vicinity of the protrusion 223 (the wall body 224).

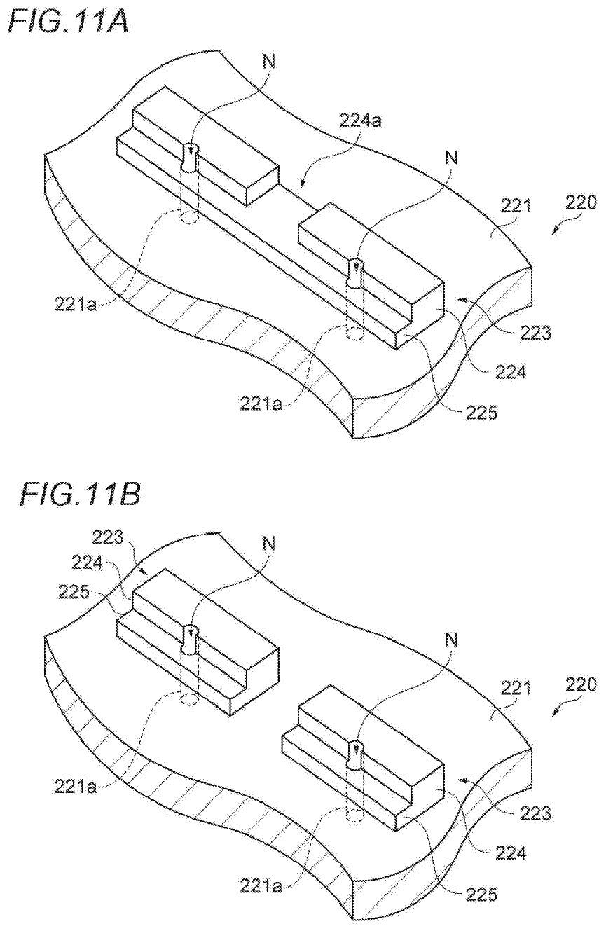

(5) As shown in FIG. 11A, the wall body 224 may be divided partially. In other words, the wall body 224 may be formed with a notch 224a.

(6) As shown in FIG. 11B, the base member 221 may be provided with a set of protrusion units so as to position the set of protrusion units including the plurality of protrusions 223 inside one magnet-insert hole 16.

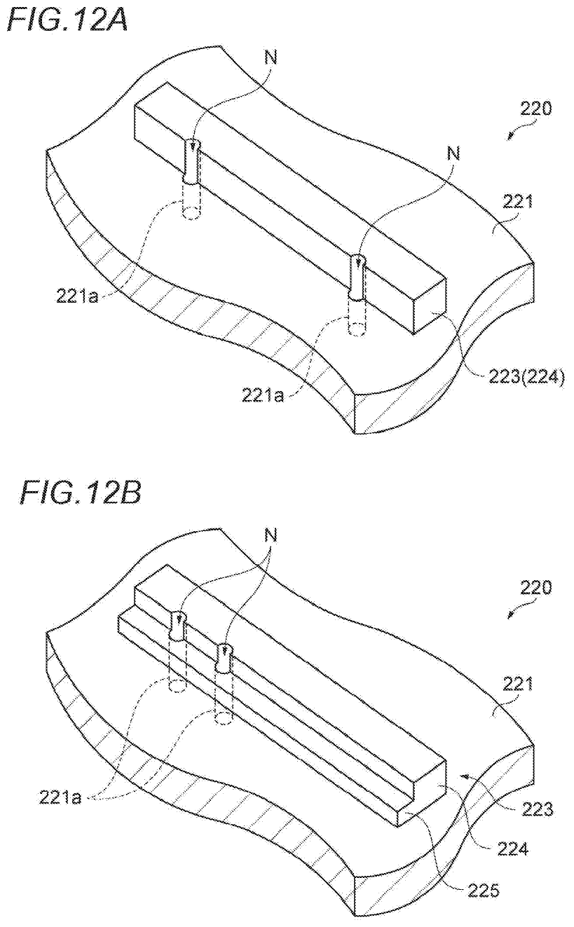

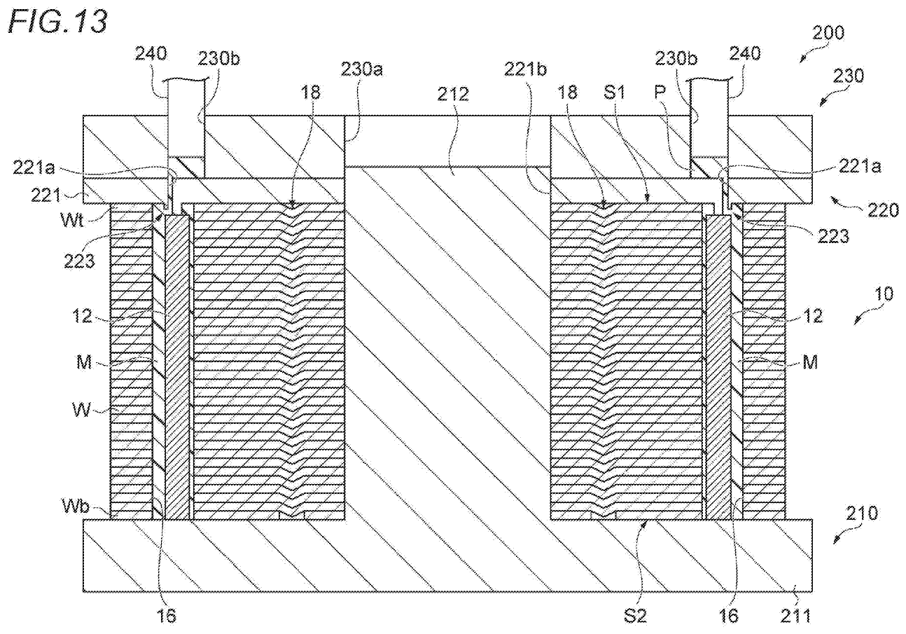

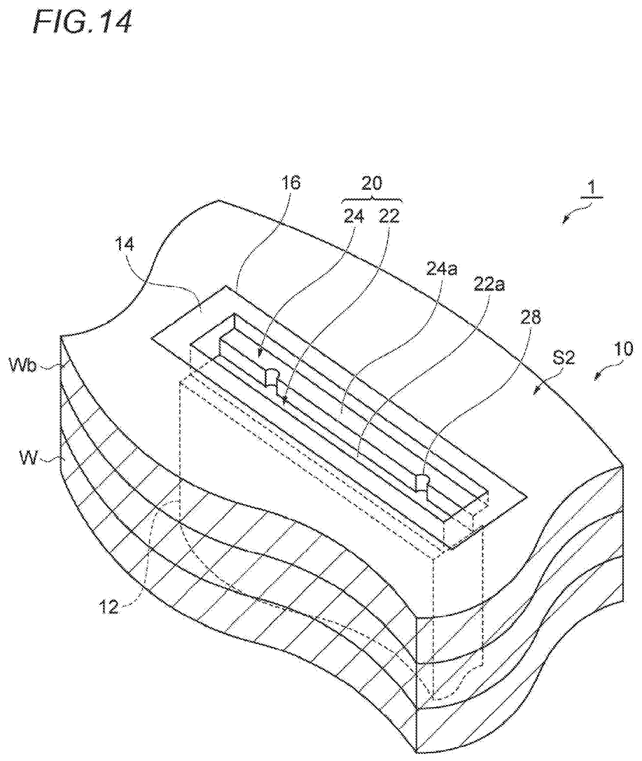

(7) As shown in FIG. 12A, it is unnecessary that the protrusion 223 should include the auxiliary wall body 225. At this time, a portion of the gate hole 221a may be provided astride the protrusion 223 (the wall body 224). That is, the discharge port N may be provided in an upper surface of the base member 221, a side surface of the protrusion 223 (the wall body 224), and an upper surface of the protrusion 223 (the wall body 224). In this case, a portion of the discharge port N provided in the upper surface of the base member 221 is positioned in the lateral vicinity of the wall body 224.

(8) As shown in FIG. 12B, at least one gate hole 221a provided in the protrusion 223 may be located eccentrically with respect to the protrusion 223 as a whole. That is, the discharge port N of the at least one gate hole 221a may be provided in an eccentric position with respect to the magnet-insert hole 16 as a whole when viewed from the height direction. In this case, the molten resin M discharged from the discharge port N of the gate hole 221a tends to obliquely flow inside the magnet-insert hole 16 toward space (right side in FIG. 12B) separated from the discharge port N. Accordingly, the permanent magnet can more flexibly be arranged with respect to the inside of the magnet-insert hole 16 by the flow of the molten resin M. This can more properly manage the position of the permanent magnet 12 with respect to the magnet-insert hole 16.

(9) When the protrusion 223 is provided with the plurality of gate holes 221a as shown in FIG. 8, injection conditions of the molten resin M injected from each of the gate holes 221a may differ. For example, the receiving hole 210a and the plunger 240 may be associated with each of the gate holes 221a on by one, and each of the plungers 240 may be driven independently by the controller Ctr. In this case, the molten resin M is discharged from the plurality of gate holes 221a to the inside of the magnet-insert hole 16 on different conditions (for example, discharge timing, a resin flow rate, and a pressure), thereby biasing the flow of the molten resin M inside the magnet-insert hole 16. As a result, the molten resin M tends to obliquely flow inside the magnet-insert hole 16 as a whole. Accordingly, the permanent magnet can more flexibly be arranged with respect to the inside of the magnet-insert hole 16 by the flow of the molten resin M. This can more properly manage the position of the permanent magnet 12 with respect to the magnet-insert hole 16.

(10) A resin guide member (a cull plate) may be arranged between the base member 221 and the laminated body 10. In this case, the resin guide member may be formed with the protrusion 223 and a resin flow path (for example, a runner groove, a gate hole) for guiding the molten resin to the magnet-insert hole 16. When the laminated body 10 directly abuts on the base member 221 and the molten resin is injected into the magnet-insert hole 16 from a side of the base member 221, the resin flow path (the runner groove) extending from the receiving hole 210a may be provided in an upper surface of the lower die 210, or the resin flow path (the runner groove) extending from the gate hole 221a toward the receiving hole 210a may be provided in a lower surface of the base member 221.

(11) As shown in FIG. 13, the molten resin M may be injected into the magnet-insert hole 16 from an upper side of the laminated body 10 with the resin guide member 220 overlapped with the upper end face S1 of the laminated body 10.

In an example shown in FIG. 13, a lower die 210 includes a base member 211, and an insertion post 212 provided on the base member 211. The insertion post 212 is positioned in substantially the center of the base member 211, and is upwardly projected from an upper surface of the base member 211. The insertion post 212 has a columnar shape, and has an external shape corresponding to the shaft hole 10a of the laminated body 10.

In the example shown in FIG. 13, the resin guide member 220 does not include the insertion post 222, and substantially the center of the base member 221 is provided with a through-hole 221b pierced in the base member 221. The through-hole 221b has a shape (substantially a circular shape) corresponding to the insertion post 212, and the insertion post 212 can be inserted into the through-hole 221b. With the resin guide member 220 overlapped with the upper end face S1 of the laminated body 10, the top of the wall body 224 may make contact with an upper end face of the permanent magnet 12, or may be spaced slightly.

In the example shown in FIG. 13, an upper die 230 is provided with a plurality of receiving holes 230b pierced in the upper die 230. The plurality of receiving holes 230b are arranged at predetermined distances so as to be positioned in places corresponding to the magnet-insert holes 16 with the laminated body 10 pinched by the lower die 210 and the upper die 230. Each of the receiving holes 230b has a columnar shape, and can receive at least one resin pellet P.

(12) The plurality of permanent magnets 12 may be inserted into one magnet-insert hole 16. In this case, the plurality of permanent magnets 12 may be adjacently arranged along a height direction inside the one magnet-insert hole 16, or may be adjacently arranged along a longitudinal direction of the magnet-insert hole 16.

(13) It is unnecessary that the gate mark 26 should be provided inside the end recess 20. In this case, as shown in FIG. 14, an air gap 28 extending from the recess bottom surface 24a of the auxiliary recess 24 toward the permanent magnet 12 may be provided in a lower end of the solidified resin 14. When the resin guide member 220 is detached from the laminated body 10, the solidified resin inside the gate hole 221a is broken in the top vicinity of the gate hole 221a (the top vicinity of the discharge port N), and is removed together with the resin guide member 220, thereby forming the air gap 28. The air gap 28 may reach the permanent magnet 12, and the permanent magnet 12 may be exposed through the air gap 28. The air gap 28 may be a groove-shaped part extending astride a step between the recess 22 and the auxiliary recess 24, or may be a recess opened in the recess bottom surface 24a of the auxiliary recess 24 without a state astride the step.

### Exemplification

### Example 1

A method for manufacturing a rotor iron core (1) according to one example of the present disclosure includes: providing an iron core body (10) including a magnet-insert hole (16), and a resin guide member (220) including a wall body (224) projected from a surface of the resin guide member (220); overlapping the iron core body (10) with the resin guide member (220), wherein the wall body (224) is positioned inside the magnet-insert hole (16) in which a permanent magnet (12) is disposed in a state where the iron core body (10) is overlapped with the resin guide member (220); and injecting a molten resin (M) into the magnet-insert hole (16) through at least one gate hole (221a) pierced and extended in the resin guide member (220), wherein a discharge port (N) of the at least one gate hole (221a) is provided in lateral vicinity of the wall body (224). In this case, the molten resin discharged from the discharge port of the gate hole to the inside of the magnet-insert hole is blocked by the wall body, and flows to a side opposite to the wall body. As a result, the permanent magnet arranged inside the magnet-insert hole is brought closer to a side of the wall body by the molten resin flowing to the side opposite to the wall body. That is, the permanent magnet is arranged in a predetermined position of the inside of the magnet-insert hole by the flow of the molten resin. This can properly manage a position of the permanent magnet with respect to the magnet-insert hole.

### Example 2

In the method of Example 1, the resin guide member (220) may include an auxiliary wall body (225) which is projected from the surface of the resin guide member (220) in the lateral vicinity of the wall body (224) and is lower than the wall body (224), and the discharge port (N) of the at least one gate hole (221a) may be provided in an upper surface of the auxiliary wall body (225). When the resin guide member is detached from the iron core body after the molten resin is solidified, the solidified resin inside the gate hole may be broken in the top vicinity of the gate hole to remain in the rotor iron core as a gate mark in a state connected integrally to the solidified resin inside the magnet-insert hole. However, according to Example 2, the discharge port of the gate hole is provided in the upper surface of the auxiliary wall body. That is, the discharge port is positioned in the inside beyond the end face of the rotor iron core. As a result, even when the gate mark occurs, the top of the gate mark becomes resistant to being projected to the outside beyond the end face of the rotor iron core. Accordingly, contact between the gate mark and other member is inhibited. This can prevent fall of the gate mark at the time of operation of the rotor iron core.

### Example 3

In the method of Example 2, the auxiliary wall body (225) may be connected integrally to the wall body (224), and the discharge port (N) of the at least one gate hole (221a) may be provided astride the auxiliary wall body (225) and the wall body (224). In this case, the molten resin discharged from the discharge port collides with the wall body immediately, and tends to flow to the side opposite to the wall body. Accordingly, the flow of the molten resin can be controlled with higher accuracy. This can more properly manage the position of the permanent magnet with respect to the magnet-insert hole.

### Example 4

In the method of any one of Examples 1 to 3, the overlapping of the iron core body (10) with the resin guide member (220) may include overlapping a lower surface (S2) of the iron core body (10) with the resin guide member (220). In this case, since the wall body is positioned on the lower end side of the magnet-insert hole, the permanent magnet arranged inside the magnet-insert hole is supported by the wall body. As a result, the molten resin discharged from the discharge port of the gate hole is blocked by the wall body and a lower end face of the permanent magnet, and tends to flow to the side opposite to the wall body. Accordingly, the flow of the molten resin can be controlled with higher accuracy. This can more properly manage the position of the permanent magnet with respect to the magnet-insert hole.

### Example 5

In the method of any one of Examples 1 to 4, the discharge port (N) of the at least one gate hole (221a) may be provided in an eccentric position with respect to the magnet-insert hole (16) from a top view of the iron core body (10). In this case, the molten resin discharged from the discharge port tends to obliquely flow inside the magnet-insert hole toward space separated from the discharge port. Accordingly, the permanent magnet can more flexibly be arranged with respect to the inside of the magnet-insert hole by the flow of the molten resin. This can more properly manage the position of the permanent magnet with respect to the magnet-insert hole.

### Example 6

In the method of any one of Examples 1 to 5, the at least one gate hole (221a) may include a plurality of gate holes (221a), and the injecting of the molten resin (M) into the magnet-insert hole (16) may include injecting the molten resin (M) into the magnet-insert hole (16) through the plurality of gate holes (221a) on different conditions. In this case, the molten resin is discharged from the plurality of gate holes to the inside of the magnet-insert hole on different conditions (for example, discharge timing, a resin flow rate, and a pressure), thereby biasing the flow of the molten resin inside the magnet-insert hole. As a result, the molten resin tends to obliquely flow inside the magnet-insert hole as a whole. Accordingly, the permanent magnet can more flexibly be arranged with respect to the inside of the magnet-insert hole by the flow of the molten resin. This can more properly manage the position of the permanent magnet with respect to the magnet-insert hole.

### Example 7

A rotor iron core (1) according to another example of the present disclosure includes an iron core body (10) including a magnet-insert hole (16); a permanent magnet (12) arranged inside the magnet-insert hole (16); and a solidified resin (14) provided inside the magnet-insert hole (16) to hold the permanent magnet (12) inside the magnet-insert hole (16). The solidified resin (14) includes a recess (22) formed in an end on a side of one end face (S2) of the iron core body (10), and an auxiliary recess (24) which is formed in the end of the iron core body and is shallower than the recess (22). The auxiliary recess (24) is positioned in lateral vicinity of the recess (22). The permanent magnet (12) is positioned closer to an inner wall surface of the magnet-insert hole (16) on a side opposite to the auxiliary recess (24) with respect to the recess (22). In this case, by the presence of the resin guide member, the solidified resin is formed with the recess and also, the permanent magnet is arranged closer to a predetermined inner wall surface of the inside of the magnet-insert hole. This can properly manage a position of the permanent magnet with respect to the magnet-insert hole.

### Example 8

In the rotor iron core (1) of Example 7, the recess (22) may be continuously adjacent to the auxiliary recess (24) so as to form a step at a boundary between the recess (22) and the auxiliary recess (24).

### Example 9

The rotor iron core of Example 7 or 8 may further include a gate mark (26) connected integrally to the solidified resin (14) so as to be outwardly projected from a recess bottom surface (24a) of the auxiliary recess (24), and it is unnecessary that a top of the gate mark (26) should be projected to an outside beyond the end face (S2) of the iron core body (16). In this case, contact between the gate mark and other member is inhibited. This can prevent fall of the gate mark.

### Example 10

The rotor iron core (1) of Example 7 or 8 may further include an air gap (28) extending from the recess bottom surface (24a) of the auxiliary recess (24) toward the permanent magnet (12). In this case, since the gate mark is not present inside the auxiliary recess, there is no fear of fall of the gate mark.

A part of reference numerals and signs used in the embodiment is listed below
1: ROTOR LAMINATED IRON CORE (ROTOR IRON CORE)
10: LAMINATED BODY (IRON CORE BODY)
12: PERMANENT MAGNET
14: SOLIDIFIED RESIN
16: MAGNET-INSERT HOLE
20: END RECESS
22: RECESS
22a: RECESS BOTTOM SURFACE
24: AUXILIARY RECESS
24a: RECESS BOTTOM SURFACE
26: GATE MARK
100: MANUFACTURING APPARATUS
200: MAGNET ATTACHMENT DEVICE (RESIN INJECTION DEVICE)
220: RESIN GUIDE MEMBER
221: BASE MEMBER
221a: GATE HOLE
223: PROTRUSION
224: WALL BODY
225: AUXILIARY WALL BODY
Ctr: CONTROLLER (CONTROL PART)
M: MOLTEN RESIN
N: DISCHARGE PORT
S1: UPPER END FACE
S2: LOWER END FACE

What is claimed is:

1. A method for manufacturing a rotor iron core, the method comprising:
providing an iron core body including a magnet-insert hole, and a resin guide member including a wall body projected from a surface of the resin guide member;
overlapping the iron core body with the resin guide member, wherein the wall body is positioned inside the magnet-insert hole in which a permanent magnet is disposed in a state where the iron core body is overlapped with the resin guide member; and
injecting a molten resin into the magnet-insert hole through at least one gate hole pierced and extended in the resin guide member, wherein a discharge port of the at least one gate hole is provided in lateral vicinity of the wall body.

2. The method according to claim 1, wherein the resin guide member includes an auxiliary wall body which is projected from the surface of the resin guide member in the lateral vicinity of the wall body, the auxiliary wall body being lower than the wall body, and
the discharge port of the at least one gate hole is provided in an upper surface of the auxiliary wall body.

3. The method according to claim 2, wherein the auxiliary wall body is connected integrally to the wall body, and
the discharge port of the at least one gate hole is provided astride the auxiliary wall body and the wall body.

4. The method according to claim 1, wherein the overlapping of the iron core body with the resin guide member includes overlapping a lower surface of the iron core body with the resin guide member.

5. The method according to claim 1, wherein the discharge port of the at least one gate hole is provided in an eccentric position with respect to the magnet-insert hole from a top view of the iron core body.

6. The method according to claim 1, wherein the at least one gate hole includes a plurality of gate holes, and
the injecting of the molten resin into the magnet-insert hole includes injecting the molten resin into the magnet-insert hole through the plurality of gate holes on different conditions.

7. A rotor iron core comprising:
an iron core body including a magnet-insert hole;
a permanent magnet arranged inside the magnet-insert hole; and
a solidified resin provided inside the magnet-insert hole to hold the permanent magnet inside the magnet-insert hole, wherein
the solidified resin includes:
a recess formed in an end on a side of one end face of the iron core body; and
an auxiliary recess formed in the end of the iron core body, the auxiliary recess being shallower than the recess,
the auxiliary recess is positioned in lateral vicinity of the recess, and
the permanent magnet is positioned closer to an inner wall surface of the magnet-insert hole on a side opposite to the auxiliary recess with respect to the recess.

8. The rotor iron core according to claim 7, wherein the recess is continuously adjacent to the auxiliary recess so as to form a step at a boundary between the recess and the auxiliary recess.

9. The rotor iron core according to claim 7, further comprising:
a gate mark connected integrally to the solidified resin, the gate mark being outwardly projected from a recess bottom surface of the auxiliary recess, and
a top of the gate mark is not projected to an outside beyond the end face of the iron core body.

10. The rotor iron core according to claim 7, further comprising:
an air gap extending from a recess bottom surface of the auxiliary recess toward the permanent magnet.
